(19) United States
(12) Patent Application Publication
(10) Pub. No.: US 2017/0091874 A1
(43) Pub. Date: Mar. 30, 2017

(54) COMMODITY SALES DATA PROCESSING APPARATUS AND METHOD FOR PREVENTING UNFAIR BEHAVIOR

(71) Applicant: TOSHIBA TEC KABUSHIKI KAISHA, Tokyo (JP)

(72) Inventor: Seiji Nakagami, Kasugai (JP)

(21) Appl. No.: 15/193,315

(22) Filed: Jun. 27, 2016

(30) Foreign Application Priority Data
Sep. 28, 2015 (JP) 2015-190092

(51) Int. Cl. G06Q 40/00; G06K 15/02; G06Q 30/00; G06Q 20/20

(52) U.S. Cl. CPC G06Q 40/123; G06Q 20/20; G06Q 20/209; G06Q 20/207; G06K 15/02; G06K 15/1802; G06Q 30/018

(57) ABSTRACT

A commodity sales data processing apparatus comprises an input module configured to receive the input of identification information capable of identifying transaction information, stored in a storage section, which relates to one transaction in a commodity sales data processing; an extraction module configured to extract the transaction information relating to the identification information received by the input module from the storage section; a summing module configured to sum a plurality of the transaction information extracted by the extraction module; and a print control module configured to print a summation receipt relating to the transaction information summed by the summing module and a summation origin receipt in the form incapable of the summation relating to the transaction information summed by the summing module.

### CROSS-REFERENCE TO RELATED APPLICATION

This application is based upon and claims the benefit of priority from Japanese Patent Application No. 2015-190092, filed Sep. 28, 2015, the entire contents of which are incorporated herein by reference.

### FIELD

Embodiments described herein relate generally to a commodity sales data processing apparatus and a method for preventing unfair behavior.

### BACKGROUND

Conventionally, in a case in which a business person who runs an export article store (such as a duty-free store) sells a sales object such as a commodity to a nonresident such as a foreign tourist, there exists a so-called tax exemption system for exempting taxes such a consumption tax relating to the sales object.

In order to receive the application of such a tax exemption system, a daily sales total amount of articles of a classification relating to tax exemption in the same store should be equal to or greater than a predetermined amount. In other words, in the same store, as long as articles are sold on the same date, even if the sales time thereof is different, the articles can be subjected to the tax exemption system. That is, the tax exemption system can be applied through summing transactions of the articles sold at different times.

Herein, in a case in which the transactions are summed to receive the application of the tax exemption system, it is necessary that the business person collects a receipt relating to a transaction serving as a summation object and provides the receipt relating to the summed transaction to the nonresident. It is necessary to carry out such a procedure so as to prevent an unfair behavior of double tax exemption caused by summing a transaction already summed in another transaction in another transaction again.

However, there is a case in which the nonresident also desires the receipt relating to the summation object for grasping each transaction time of the summed different transactions.

### DESCRIPTION OF THE DRAWINGS

FIG. 1 is an illustration diagram illustrating an example of the configuration of a POS system according to an embodiment;

FIG. 2 is a block diagram illustrating the hardware configuration of a store server;

FIG. 3 is an illustration diagram illustrating an example of a commodity master file;

FIG. 4 is an illustration diagram illustrating an example of a transaction information table;

FIG. 5 is a block diagram illustrating the hardware configuration of a POS terminal;

FIG. 6 is a block diagram illustrating the characteristic functional components of each device of the POS system.

FIG. 7 is an illustration diagram illustrating an example of a summation object receipt;

FIG. 8 is an illustration diagram illustrating an example of a summation receipt;

FIG. 9 is an illustration diagram illustrating an example of a summation origin receipt; and

FIG. 10 is a flowchart illustrating an example of a transaction summing processing.

### DETAILED DESCRIPTION

In accordance with an embodiment, a commodity sales data processing apparatus comprises an input module, an extraction module, a summing module, and a print control module. The input module receives the input of identification information capable of identifying transaction information, stored in a storage section, which relates to one transaction in a commodity sales data processing. The extraction module extracts the transaction information relating to the identification information received by the input module from the storage section. The summing module sums a plurality of the transaction information extracted by the extraction module. The print control module prints a summation receipt relating to the transaction information summed by the summing module and a summation origin receipt in the form incapable of the summation relating to the transaction information summed by the summing module.

Hereinafter, an embodiment about the commodity sales data processing apparatus and a method for preventing unfair behavior is described in detail with reference to the accompanying drawings. The embodiment described hereinafter is only one embodiment of the commodity sales data processing apparatus and the method for preventing an unfair behavior, and the configuration and specification thereof are not limited to this embodiment. The commodity sales data processing apparatus according to the present embodiment is an application example to a POS (Point Of Sales) terminal, introduced to a store such as a duty-free store (a store engaging in tax exempt sales), which carries out a commodity sales data processing relating to registration and settlement of commodities relating to one transaction.

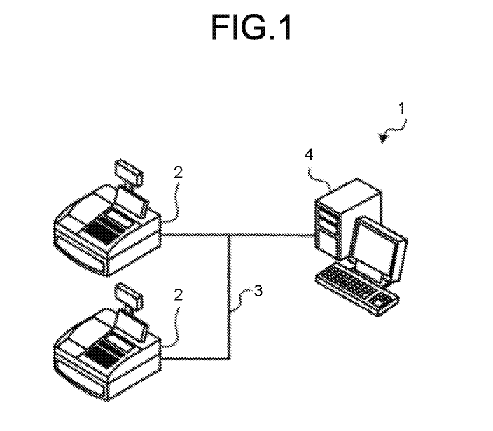

FIG. 1 is an illustration diagram illustrating an example of the configuration of a POS system 1 according to the present embodiment. The POS system 1 includes a POS terminal 2 and a store server 4. The POS system 1 connects the POS terminal 2 with the store server 4 via an in-store network 3. The in-store network 3 is, for example, an LAN (Local Area Network) for connecting each device arranged in the store.

The POS terminal 2 is the commodity sales data processing apparatus used in the commodity sales data processing in the store such as the duty-free store which can exempt a tax relating to a commodity to sell the commodity. The store server 4 is an information processing apparatus for collectively managing the POS terminals 2 arranged in the store.

Next, the hardware configuration of the POS terminal 2 and that of the store server 4 are described.

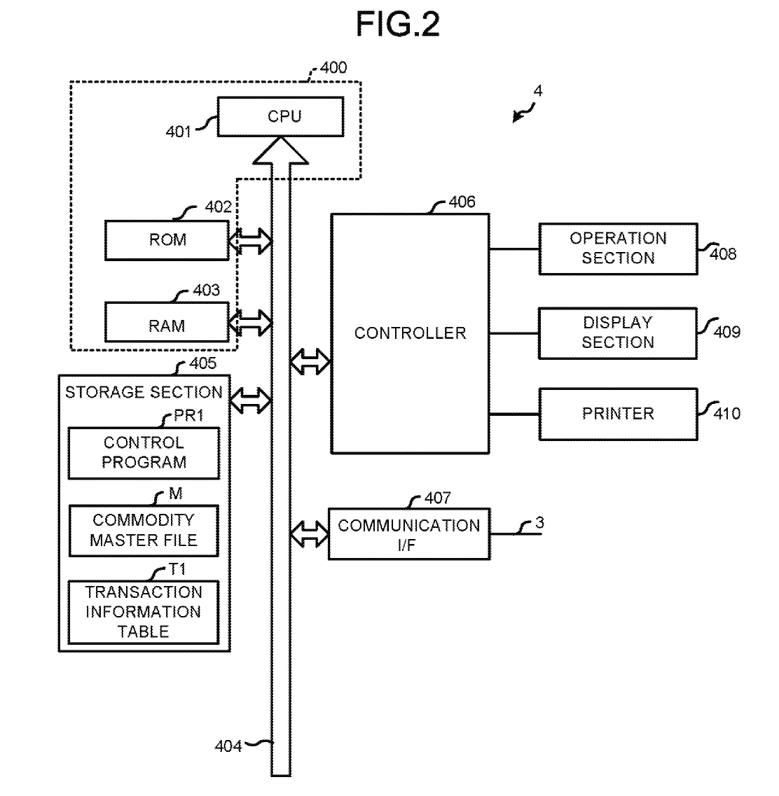

First, the hardware configuration of the store server 4 is described. FIG. 2 is a block diagram illustrating the hardware configuration of the store server 4. The store server 4 includes a control section 400 for controlling each section. The control section 400 comprises a CPU (Central Processing Unit) 401, a ROM (Read Only Memory) 402, and a RAM (Random Access Memory) 403 as shown in FIG. 2. The CPU 401 is connected with the ROM 402 and the RAM 403 via a bus line 404 such as an address bus line, a data bus line, and the like. The CPU 401 concentratedly controls each section. The ROM 402 is a storage medium for storing various programs and data. The RAM 403 is a storage medium for temporarily storing various programs or rewriting various data.

The control section 400 is connected with a storage section 405, a controller 406, and a communication I/F 407 via the bus line 404.

The controller 406 is connected with an operation section 408, a display section 409 and a printer 410. The controller 406 controls each section connected therewith according to an instruction from the control section 400. The operation section 408 is a keyboard, a mouse, and the like for inputting an operation. The display section 409 is a liquid crystal display. The printer 410 is a printing device for printing various information.

The communication I/F 407 is connected with the POS terminal 2 via the in-store network 3.

The storage section 405 is, for example, a storage device such as an HDD (Hard Disk Drive), an SSD (Solid State Drive), and the like. The storage section 405 stores a control program PR1, a commodity master file M and a transaction information table T1. The control program PR1 is used to realize characteristic functions of the store server 4.

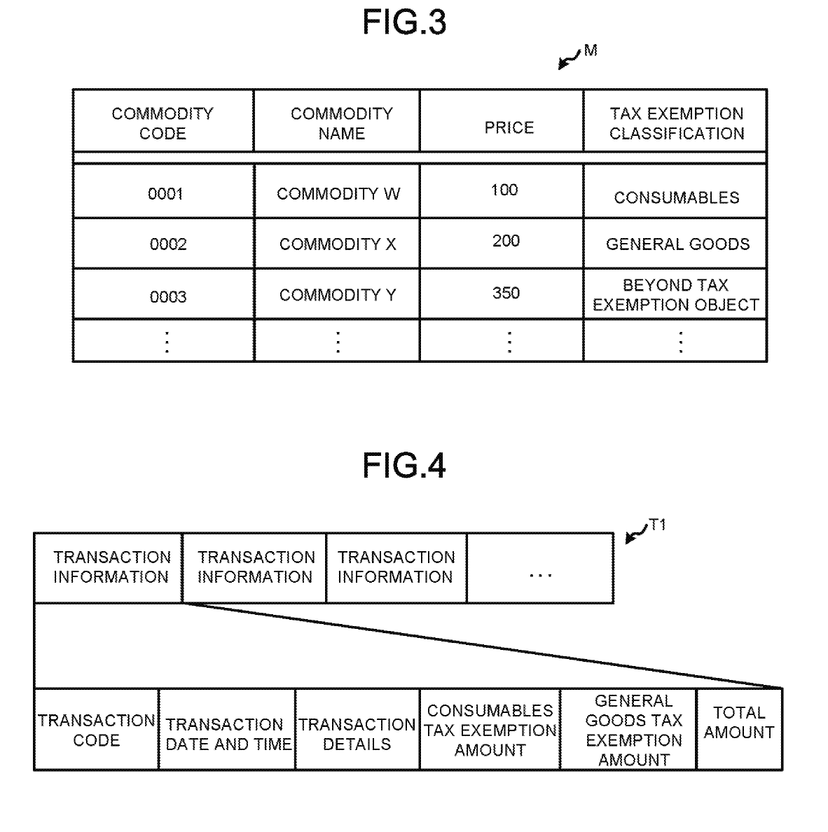

The commodity master file M is a database for storing information of each commodity. Herein, FIG. 3 is an illustration diagram illustrating an example of the commodity master file M. The commodity master file M stores the information relating to each commodity. The commodity master file M stores a commodity code, a commodity name, a price, and tax exemption classification associated with one another. The commodity code is identification information capable of identifying a commodity. The commodity name is the name of the commodity. The price is the price of the commodity. The tax exemption classification is a classification relating to a tax exemption system for exempting the tax relating to an article to be sold to a nonresident such as a foreign tourist. The tax exemption classification includes “consumables”, “general goods” and “beyond tax exemption object”. The “consumables” correspond to commodities such as foods, beverages, chemicals, cosmetics and other consumables. The “general goods”, which are articles serving as tax exemption objects, refer to articles used in the ordinary life other than the consumables. For example, the “general goods” correspond to commodities such as household appliances, clothes, bags, and the like. The “beyond tax exemption object” refers to a non-tax exemption object. Further, the above-mentioned tax exemption classification is only an example of a cost modification classification, and other cost modification classifications can be employed.

The transaction information table T1 is a database for storing transaction information relating to one transaction in the commodity sales data processing. Herein, FIG. 4 is an illustration diagram illustrating an example of the transaction information table T1. The transaction information table T1 stores one or more transaction information. The transaction information includes a transaction code, transaction date and time, transaction details, consumables tax exemption amount, general goods tax exemption amount, cost modification classification, and total amount associated with one another. The transaction code is identification information capable of identifying one transaction in the commodity sales data processing. The transaction date and time is information indicating date and time when one transaction is carried out. The transaction details are information indicating details of commodities sold in the one transaction. The consumables tax exemption amount is information indicating tax exemption amount of a commodity of which the tax exemption classification belongs to the consumables. The general goods tax exemption amount is information indicating tax exemption amount of a commodity of which the tax exemption classification belongs to the general goods. The cost modification classification refers to tax exempt status, temporary discounts, and special discounts. The total amount is total amount of commodities sold in one transaction. Further, the transaction information table T1 can store not only the transaction details relating to one transaction but also the transaction information relating to summation of plural transactions.

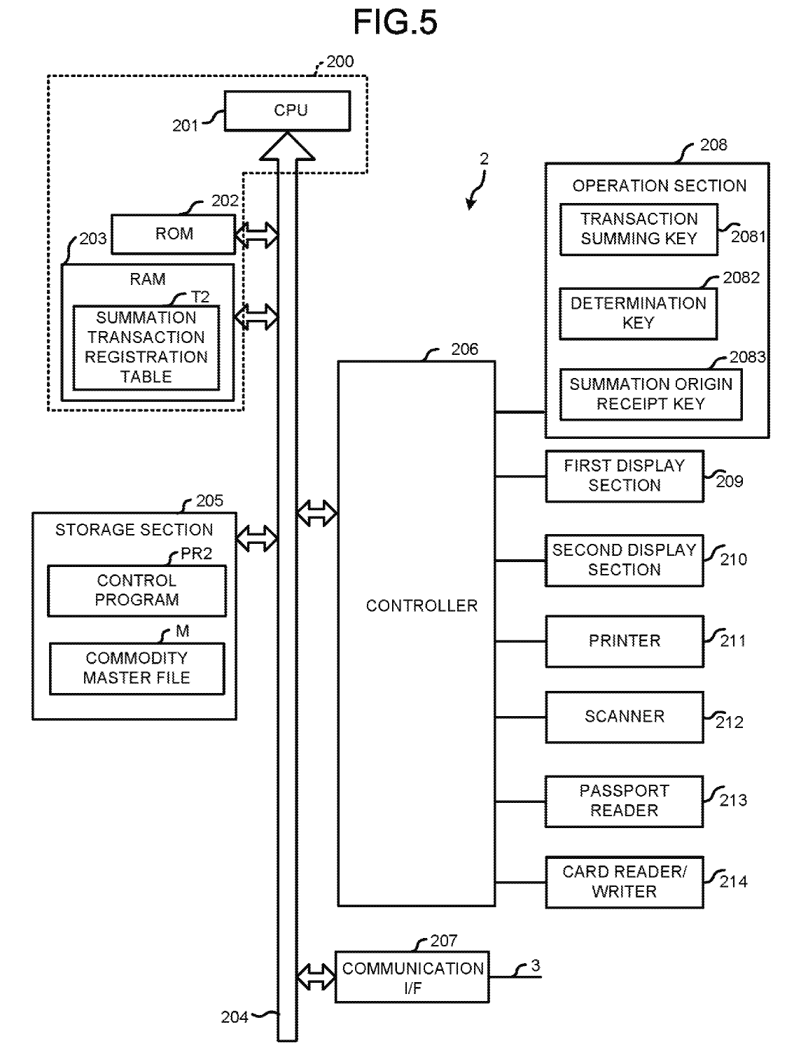

Next, the hardware configuration of the POS terminal 2 is described. FIG. 5 is a block diagram illustrating the hardware configuration of the POS terminal 2. The POS terminal 2 includes a control section 200 for controlling each section. The control section 200 comprises a CPU 201, a ROM 202 and a RAM 203 as shown in FIG. 5. The CPU 201 is connected with the ROM 202 and the RAM 203 via a bus line 204 such as the address bus line, the data bus line and the like. The CPU 201 concentratedly controls each section. The ROM 202 is a storage medium for storing various programs and data. The RAM 203 is a storage medium for temporarily storing various programs or rewriting various data. Further, the RAM 203 uses a part of the area thereof as a storage area of a summation transaction registration table T2. The summation transaction registration table T2 stores one or more transaction information relating to the transaction serving as the summation object.

The control section 200 is connected with a storage section 205, a controller 206, and a communication I/F 207 via the bus line 204.

The controller 206 is connected with an operation section 208, a first display section 209, a second display section 210, a printer 211, a scanner 212, a passport reader 213, and a card reader/writer 214. The operation section 208 is a keyboard, a mouse, and the like for inputting an operation. The operation section 208 comprises a transaction summing key 2081, a determination key 2082 and a summation origin receipt key 2083. The transaction summing key 2081 is used to declare the start of a transaction summing processing. Herein, the transaction summing processing refers to a processing of summing plural transactions. The determination key 2082 is used to determine a transaction serving as a summation object. The summation origin receipt key 2083 is used to print a receipt of a summation origin of summed transactions.

The first display section 209 and the second display section 210 are, for example, display devices such as the liquid crystal display. The first display section 209 and the second display section 210 display various information such as the name of a commodity, the price of the commodity registered through the commodity sales data processing, total amount and change amount of one transaction of which settlement is declared. The first display section 209 mainly displays various information to a store clerk. The second display section 210 mainly displays various information to a customer. Further, the first display section 209 and the second display section 210 may include a touch panel. In this case, the touch panel functions as the operation section 208.

The printer 211 is a printing device for printing a receipt, some sort of paper record describing at least one aspect of a transaction, or a journal. The printer 211 prints the transaction information on a paper such as a rolled paper to output a receipt.

The scanner 212 can be a laser-type hand scanner or an optical reading-type vertical scanner. The scanner 212 optically reads a code such as a barcode, a two-dimensional code and the like attached to a commodity.

The passport reader 213 is a reading device for reading information held in a passport, passport card, military document, diplomatic document, government issue identification, or some other travel document such as boarding pass. In the embodiment, the passport reader 213 has an OCR (Optical Character Recognition) function for optically reading character strings recorded in the passport.

The card reader/writer 214 is used to read and write information held in the storage medium of a card.

The communication I/F 207 is connected with the store server 4 via the in-store network 3.

The storage section 205 is, for example, a storage device such as an HDD, an SSD, and the like. The storage section 205 stores a control program PR2 and a commodity master file M. The control program PR2 is used to realize characteristic functions of the POS terminal 2. The commodity master file M refers to the commodity master file M stored in the storage section 405 of the store server 4 and sent from the store server 4.

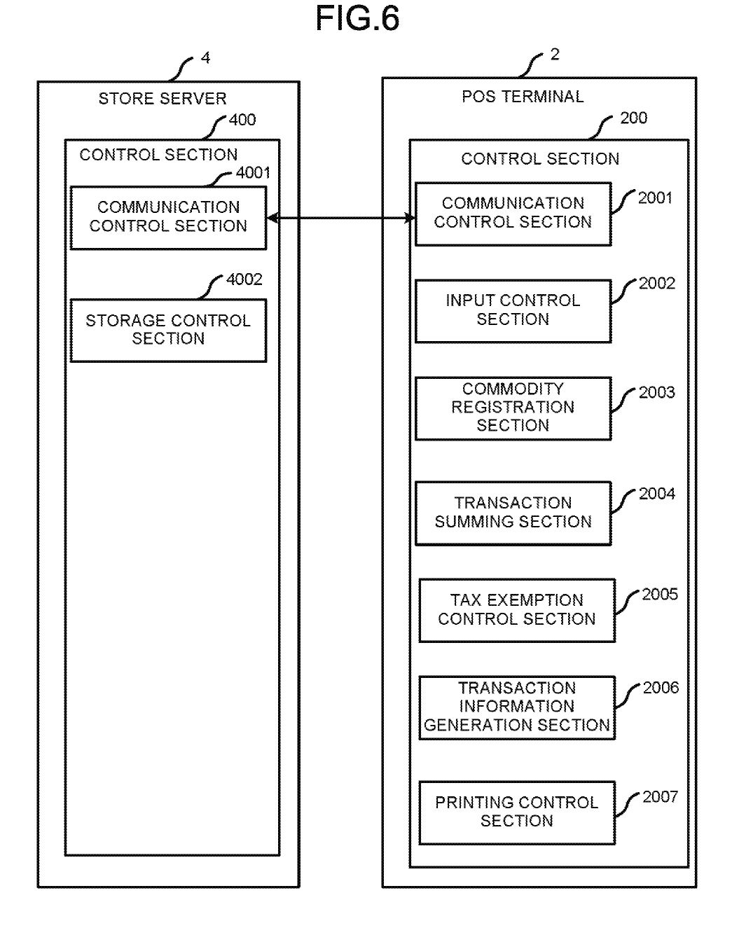

Next, the characteristic functions of each device of the POS system 1 are described. Herein, FIG. 6 is a block diagram illustrating the characteristic functional components of each device of the POS system 1.

First, the characteristic functions of the store server 4 are described.

The CPU 401 of the control section 400 copies or decompresses the control program PR1 in the storage section 405 on the RAM 403 and operates according to the control program PR1 to generate each function section shown in FIG. 6 on the RAM 403. Specifically, the control section 400 comprises a communication control section 4001 and a storage control section 4002 as the function sections.

The communication control section 4001 controls the communication I/F 407 to carryout communication via the in-store network 3. For example, the communication control section 4001 regularly sends the commodity master file M to the POS terminal 2. Further, the communication control section 4001 receives the transaction information from the POS terminal 2. Alternatively, in a case of receiving a transaction code, the communication control section 4001 sends the transaction information corresponding to the transaction code to the POS terminal 2.

The storage control section 4002 controls a processing of enabling the storage section 405 to store various information. The storage control section 4002 enables the transaction information table T1 to store the transaction information received by the communication control section 4001. Further, in a case in which the communication control section 4001 receives the transaction code, the storage control section 4002 extracts the corresponding transaction information from the transaction information table T1. The storage control section 4002 enables the transaction information table T1 to store not only the transaction information relating to one transaction but also the transaction information relating to the summation of plural transactions.

Next, the characteristic functions of the POS terminal 2 are described.

The CPU 201 of the control section 200 copies or decompresses the control program PR2 in the storage section 205 on the RAM 203 and operates according to the control program PR2 to generate each function section shown in FIG. 6 on the RAM 203. Specifically, the control section 200 comprises a communication control section 2001, an input control section 2002, a commodity registration section 2003, a transaction summing section 2004, a tax exemption control section 2005, a transaction information generation section 2006 and a printing control section 2007 as the function sections.

The communication control section 2001 controls the communication I/F 207 to execute communication via the in-store network 3. For example, the communication control section 2001 regularly receives the commodity master file M from the store server 4. Further, the communication control section 2001 sends the transaction information relating to one transaction to the store server 4. Further, the communication control section 2001 sends the transaction code to the store server 4. In this way, the communication control section 2001 requests the transaction information corresponding to the sent transaction code. Then, the communication control section 2001 receives the transaction information from the store server 4. Further, the communication control section 2001 sends the transaction information relating to the summation of plural transactions to the store server 4.

The input control section 2002 serving as an input module controls the scanner 212 to receive the input of the transaction code. Alternatively, the input control section 2002 controls the operation section 208 to receive the input of the transaction code. Furthermore, the input control section 2002 receives the input of an operation for executing the transaction summing processing from the transaction summing key 2081.

The commodity registration section 2003 registers the commodity identified by the commodity code received by the input control section 2002 as the commodity serving as the sales object. In a case in which the input control section 2002 receives the commodity code of the commodity serving as the sales object, the commodity registration section 2003 reads out the information associated with the commodity code from the commodity master file M. Then, the commodity registration section 2003 registers the information relating to the commodity serving as the sales object as the commodity serving as the sales object.

The transaction summing section 2004 sums the transaction information in the transaction summing processing. Specifically, in a case in which the input control section 2002 receives the transaction code, the transaction summing section 2004 enables the communication control section 2001 to send the input transaction code. In this way, the transaction summing section 2004 serving as the extraction module extracts the transaction information relating to the transaction code received by the input control section 2002 from the transaction information table T1. Then, the transaction summing section 2004 enables the summation transaction registration table T2 to store the transaction information relating to the transaction code received by the communication control section 2001 from the store server 4. The transaction summing section 2004 repeatedly executes the processing of enabling the summation transaction registration table T2 to store the above-mentioned transaction information until the determination key 2082 is pressed or otherwise activated to enable the summation transaction registration table T2 to store plural transaction information.

The transaction summing section 2004 serving as a summing module sums the plural transaction information stored in the summation transaction registration table T2 up in one transaction information if it is detected that the determination key 2082 is pressed. Further, the transaction summing section 2004 sums a sales total amount of the plural transaction information serving as the summation object at the time of the summation of the transaction information. In other words, the transaction summing section 2004 calculates the sales total amount of the commodities of which the tax exemption classification belongs to the general goods, the sales total amount of the commodities of which the tax exemption classification belongs to the consumables and the sales total amount of all the commodities.

The tax exemption control section 2005 determines whether or not the commodity serving as the sales object is a tax exemption object. Specifically, the tax exemption control section 2005 calculates the sales total amount of the commodities serving as the sales objects for each tax exemption classification. Then, the tax exemption control section 2005 determines whether or not the sales total amount of the commodities of the tax exemption classification is in a range of tax exemption standard amount. In a case in which the sales total amount of the commodities of the tax exemption classification is in the range of the tax exemption standard amount, the tax exemption control section 2005 determines that the commodity of the corresponding tax exemption classification is the tax exemption object. On the other hand, in a case in which the sales total amount of the commodities of the tax exemption classification is beyond the range of the tax exemption standard amount, the tax exemption control section 2005 determines that the commodity of the corresponding tax exemption classification is not the tax exemption object. Herein, the tax exemption standard amount refers to the amount determined by the tax exemption system for exempting the tax. In other words, the tax exemption standard amount is amount serving as a reference indicating whether to exempt the tax relating to the commodity of the tax exemption classification. The tax exemption standard amount can be set to different amount for each tax exemption classification. In the tax exemption standard amount, for example, 5,000 yen to 500,000 yen is preset for the tax exemption classification “consumables”, and 10,000 yen is preset for the tax exemption classification “general goods”. Then, the tax exemption control section 2005 calculates the tax exemption amount exempted from the tax for each tax exemption classification. In other words, the tax exemption control section 2005 calculates the consumables tax exemption amount and the general goods tax exemption amount.

Further, in a case in which the transaction summing section 2004 sums the plural transaction information, the tax exemption control section 2005 calculates the tax exemption amount for the summed transaction information. The tax exemption control section 2005 calculates the tax exemption amount according to the sales total amount of the commodities of which the tax exemption classification belongs to the general goods summed by the transaction summing section 2004. Further, the tax exemption control section 2005 calculates the tax exemption amount according to the sales total amount of the commodities of which the tax exemption classification belongs to the consumables summed by the transaction summing section 2004. However, in a case in which the tax exemption amount is already exempted from the tax in the transaction serving as the summation object, if the tax exemption amount is contained in the tax exemption amount again, the tax exemption control section 2005 may repeatedly exempt the tax. Thus, the tax exemption control section 2005 calculates the amount obtained by subtracting the tax exemption amount exempted from the tax in the transaction serving as the summation object from the tax exemption amount calculated according to the sales total amount as the tax exemption amount based on the summation. In other words, the tax exemption control section 2005 calculates the consumables tax exemption amount and the general goods tax exemption amount for the summed transaction information.

The transaction information generation section 2006 generates the transaction information. In a case in which a commodity sales data registration processing relating to one transaction is completed, the transaction information generation section 2006 generates the transaction information relating to one transaction. Further, in a case in which a plurality of transactions is summed and the tax exemption amount is recalculated, the transaction information generation section 2006 generates the transaction information relating to the summation of a plurality of the transactions. The transaction information relating to the summation of a plurality of the transactions, similar to the transaction information relating to one transaction, includes a transaction code, transaction date and time, transaction details, consumables tax exemption amount, general goods tax exemption amount and total amount associated with one another. The transaction code is identification information capable of identifying the transaction information relating to the summed transactions. The transaction date and time is information indicating date and time when the transaction information relating to the summed transactions is generated. The transaction details are information indicating the transaction code, the transaction date and time, the transaction details and total amount not containing the tax of the transaction information serving as the summation object. The consumables tax exemption amount is information obtained by recalculating the tax exemption amount of the commodity of which the tax exemption classification belongs to the consumables. The general goods tax exemption amount is information obtained by recalculating the tax exemption amount of the commodity of which the tax exemption classification belongs to the general goods. The total amount is the total amount of the commodities sold in the summed transactions.

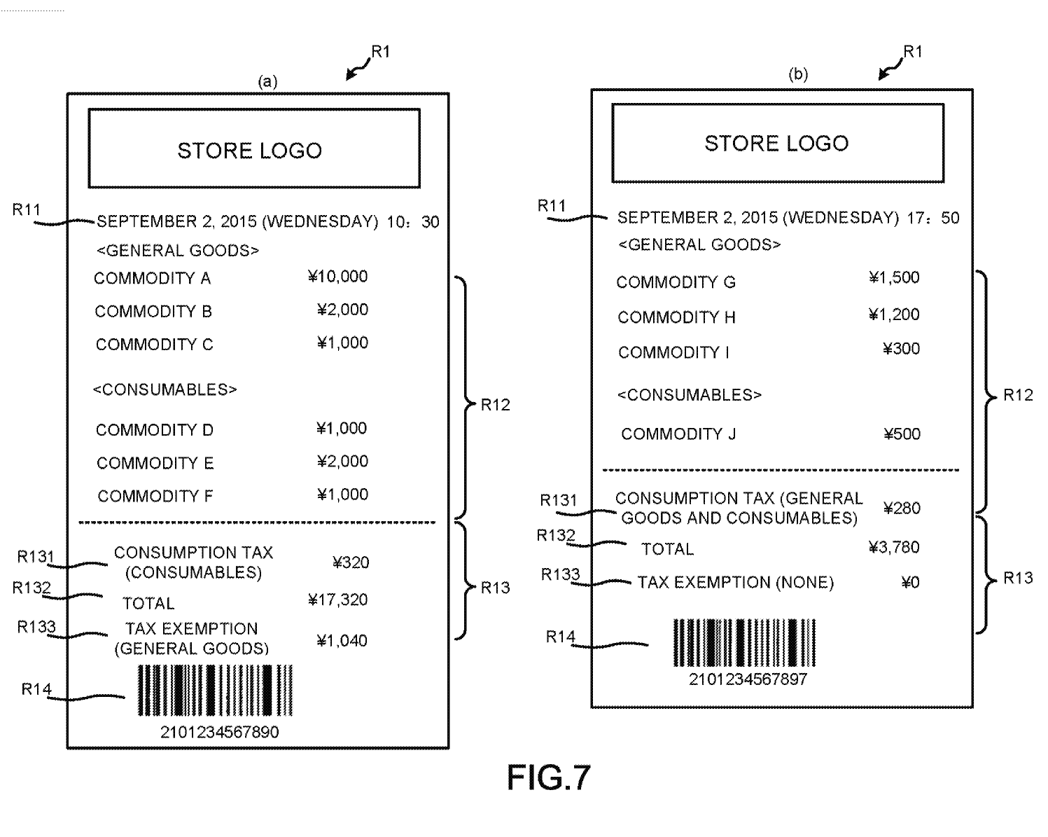

The printing control section 2007 controls the printer 211 to print a receipt. The printing control section 2007 prints a summation object receipt serving as a receipt relating to the transaction information serving as the summation object. Herein, FIG. 7 is an illustration diagram illustrating an example of a summation object receipt R1. FIG. 7 (a) is an illustration diagram indicating the summation object receipt R1 in a case in which the commodities of which the tax exemption classification is the general goods are exempted from the tax. FIG. 7 (b) is an illustration diagram indicating the summation object receipt R1 in a case in which the commodities are not exempted from the tax. The printing control section 2007 prints transaction date and time R11, transaction details R12, a totalization result R13 and a transaction code R14 on the summation object receipt R1.

The transaction date and time R11 is transaction date and time of the transaction information. The transaction details R12 are transaction details of the transaction information. The totalization result R13 is a totalization result of various information relating to one transaction. More specifically, the printing control section 2007 prints a tax R131, total amount R132 and tax exemption amount R133 in the totalization result R13. The tax R131 is the totalization result of the consumption tax relating to the commodities relating to one transaction. The total amount R132 is the totalization result of sales prices containing the consumption tax of the commodities relating to one transaction. The tax exemption amount R133 is the totalization result of the tax exemption amount of the commodities relating to one transaction. The transaction code R14 is a transaction code of the transaction information. More specifically, a transaction code converted to a code symbol and a number indicating the transaction code are printed in the transaction code R14. A two-dimensional code is printed in the transaction code R14 shown in FIG. 7; however, the present invention is not limited to this, and a three-dimensional code or a patterning may be printed. Further, the number is printed in the transaction code R14; however, the present invention is not limited to this, and a character string or a combination of the number and the character string may be printed.

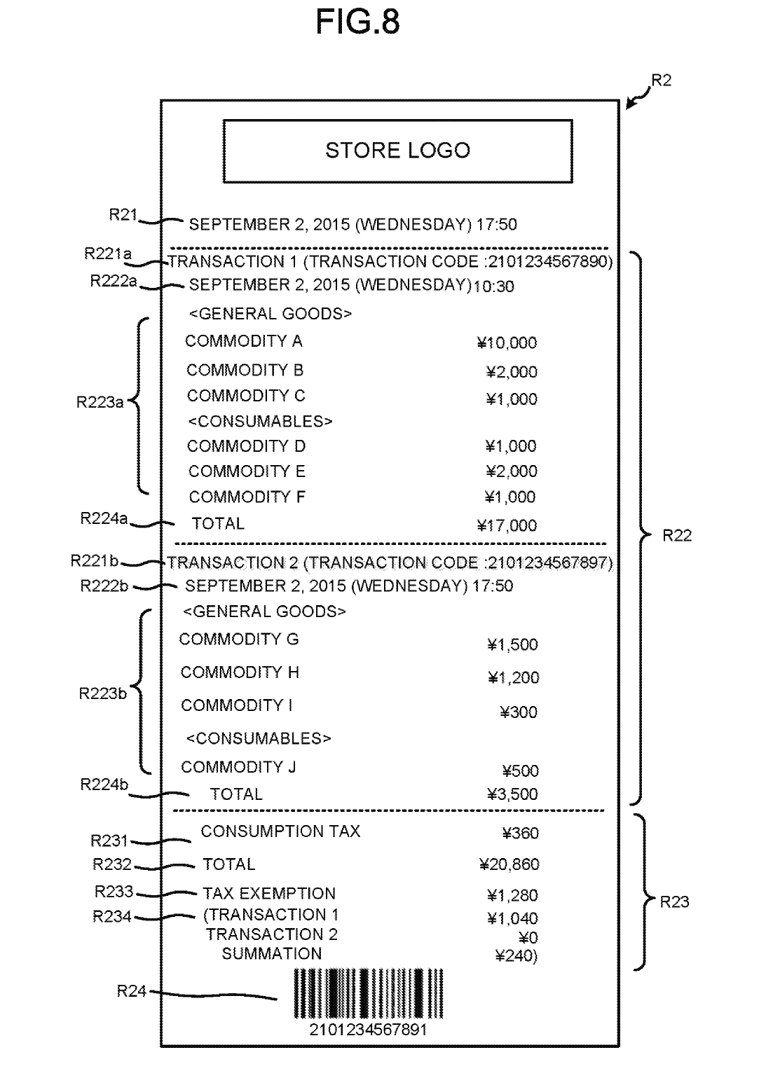

The printing control section 2007 serving as a print control module prints a summation receipt relating to the transaction information summed by the transaction summing section 2004. Herein, FIG. 8 is an illustration diagram illustrating an example of a summation receipt R2. The summation receipt R2 shown in FIG. 8 is the summation receipt R2 in a case in which the summation object receipts R1 shown in FIG. 7 (a) and FIG. 7 (b) are summed. The printing control section 2007 prints summing transaction date and time R21, summing transaction details R22, a summation totalization result R23 and a summing transaction code R24 on the summation receipt R2.

The summing transaction date and time R21 is transaction date and time of the transaction information relating to the summed transactions. The summing transaction details R22 are transaction details of the transaction information relating to the summed transactions. More specifically, the printing control section 2007 prints summation object transaction codes R221a and R221b, summation object transaction date and time R222a and R222b, summation object transaction details R223a and R223b and summation object total amount R224a and R224b in the summing transaction details R22. The summation object transaction codes R221a and R221b are numbers indicating the transaction codes of the transaction information serving as the summation objects. The summation object transaction date and time R222a and R222b are the transaction date and time of the transaction information serving as the summation objects. The summation object transaction details R223a and R223b are the transaction details of the transaction information serving as the summation objects. The summation object total amount R224a and R224b are the total amount not containing the tax relating to one transaction of the transaction information serving as the summation objects.

The summation totalization result R23 is a totalization result of various information of the transaction information relating to the summed transactions. More specifically, the printing control section 2007 prints a tax R231, total amount R232, tax exemption amount R233 and tax exemption amount items R234 in the summation totalization result R23. The tax R231 is the totalization result of the taxes relating to the commodities contained in the transaction information relating to the summed transactions. The total amount R232 is the totalization result of the sales prices containing the taxes of the commodities contained in the transaction information relating to the summed transactions. The tax exemption amount R233 is the totalization result of the tax exemption amount of the commodities contained in the transaction information relating to the summed transactions. The tax exemption amount items R234 are items of the tax exemption amount of the commodities contained in the transaction information relating to the summed transactions. The tax exemption amount items R234 shown in FIG. 8 indicate that the amount exempted from the tax in the transaction 1 serving as the summation object is 1,040 yen, the amount exempted from the tax in the transaction 2 serving as the summation object is 0 yen, and through summing the transactions, the amount exempted from the tax is 240 yen.

The summing transaction code R24 is a transaction code of the transaction information relating to the summed transactions. More specifically, a transaction code converted to a code symbol and a number indicating the transaction code are printed in the summing transaction code R24. A two-dimensional code is printed in the summing transaction code R24 shown in FIG. 8; however, the present invention is not limited to this, and a three-dimensional code or a patterning may be printed. Further, the number is printed in the summing transaction code R24; however, the present invention is not limited to this, and a character string or a combination of the number and the character string may be printed. In this way, the printing control section 2007 prints the summation receipt R2 in the form of capable of the summation on which the summing transaction code R24 is printed. In this way, in a case in which there is a commodity which is not a tax exemption object even if the commodity is summed, the nonresident can enable the transaction to be summed to make the commodity the tax exemption object.

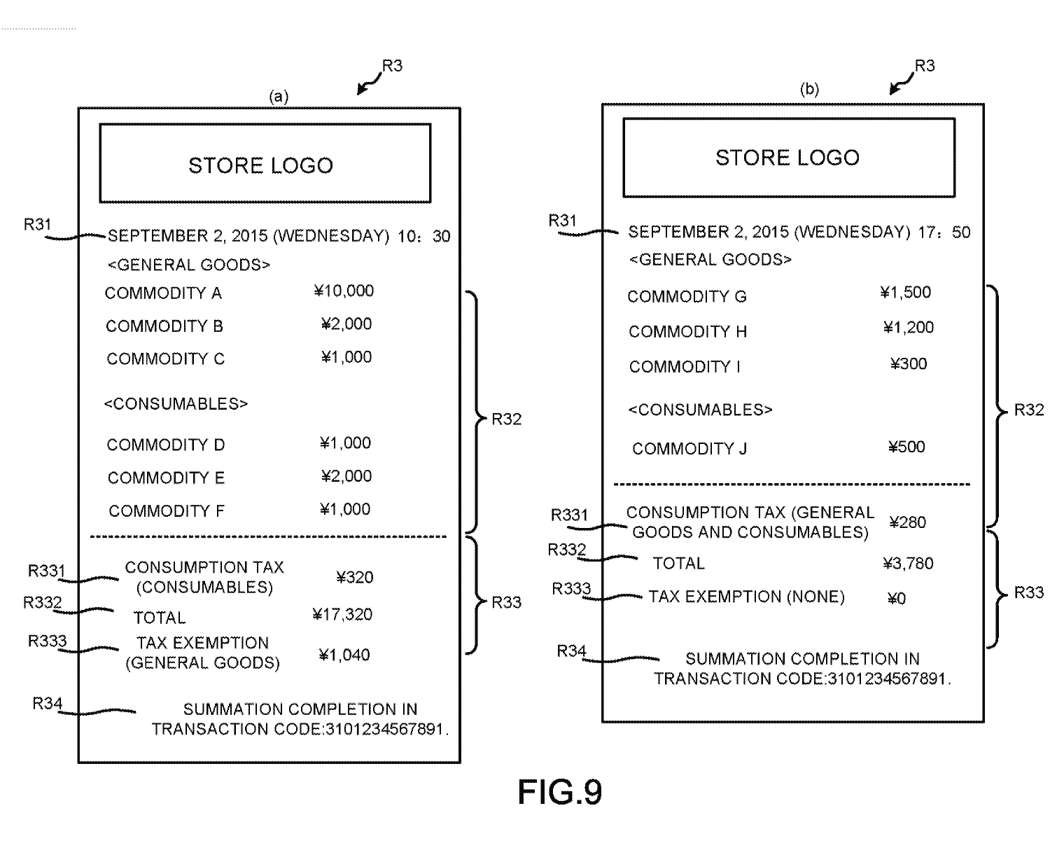

Further, the printing control section 2007 prints a summation origin receipt relating to the transaction information of a summation origin summed by the transaction summing section 2004. Herein, FIG. 9 is an illustration diagram illustrating an example of a summation origin receipt R3. The summation origin receipt R3 shown in FIG. 9 indicates the summation origin receipt R3 relating to the transaction information of the summation origin of the summation receipt R2 shown in FIG. 8. The summation origin receipt R3 is substantially identical to the summation object receipt R1, but different from the summation object receipt R1 in that the transaction code corresponding to the transaction code R14 is not printed. In this way, the printing control section 2007 can prevent unfair behavior. In other words, the malicious nonresident cannot sum the transaction already summed in another transaction in another transaction again to carry out the unfair behavior of double tax exemption.

The printing control section 2007 prints transaction date and time R31, transaction details R32, a totalization result R33 and summation completion information R34 in the summation origin receipt R3. The transaction date and time R31, the transaction details R32 and the totalization result R33 are identical to the transaction date and time R11, the transaction details R12 and the totalization result R13 of the transaction information serving as the summation object of the summation receipt R2 relating to the summation origin receipt R3. The printing control section 2007 prints a tax R331, total amount R332 and tax exemption amount R333 in the totalization result R33. Further, the tax R331, the total amount R332 and the tax exemption amount R333 are identical to the tax R131, the total amount 8132 and the tax exemption amount R133 of the transaction information serving as the summation object of the summation receipt R2 relating to the summation origin receipt R3. The summation completion information R34 is information indicating that the summation origin receipt R3 is a summation completion receipt. Further, the summation completion information R34 contains a transaction code of the summed transaction information. In this way, the printing control section 2007 prints the summation origin receipt R3 in the form incapable of the summation on which the summation completion information R34 is printed instead of the transaction code R14 or the summing transaction code R24. In this way, the malicious nonresident cannot sum the transaction already summed in another transaction in another transaction again to carry out the unfair behavior of the double tax exemption.

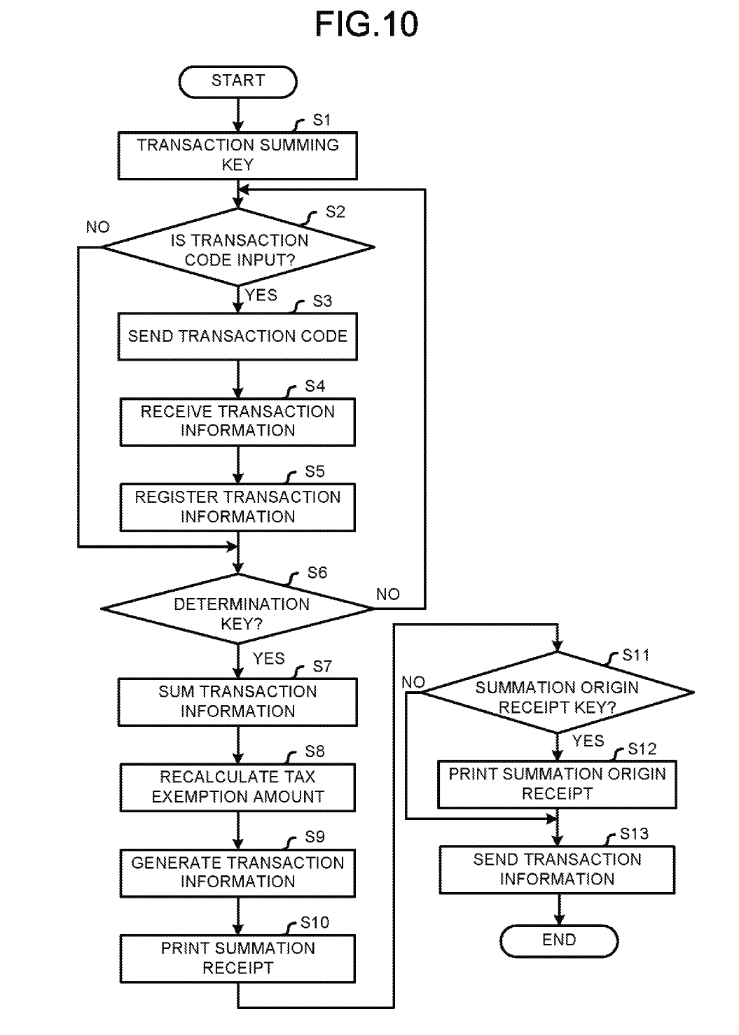

Next, the transaction summing processing executed by the POS terminal 2 is described. Herein, FIG. 10 is a flowchart illustrating an example of the transaction summing processing executed by the POS terminal 2 according to the embodiment.

First, if it is detected that the transaction summing key 2081 is pressed, the input control section 2002 of the POS terminal 2 starts the transaction summing processing (Act S1).

Then, the input control section 2002 of the POS terminal 2 determines whether to detect the input of the transaction code (Act S2). In a case in which the input of the transaction code is not detected (No in Act S2), the input control section 2002 of the POS terminal 2 proceeds to the processing in Act S6.

On the other hand, in a case in which the input of the transaction code is detected (Yes in Act S2), the communication control section 2001 of the POS terminal 2 sends the input transaction code to the store server 4 (Act S3). Next, the communication control section 2001 of the POS terminal 2 receives the transaction information corresponding to the transaction code sent from the store server 4 (Act S4). Then, the transaction summing section 2004 of the POS terminal 2 enables the summation transaction registration table T2 to store the received transaction information (Act S5).

Sequentially, the transaction summing section 2004 of the POS terminal 2 determines whether or not the press on the determination key 2082 is detected (Act S6). In a case in which the press on the determination key 2082 is not detected (No in Act S6), the transaction summing section 2004 of the POS terminal 2 proceeds to the processing in Act S2.

On the other hand, in a case in which the press on the determination key 2082 is detected (Yes in Act S6), the transaction summing section 2004 of the POS terminal 2 sums the transaction information (Act S7). Next, the tax exemption control section 2005 of the POS terminal 2 recalculates the tax exemption amount (Act S8). Then, the transaction summing section 2004 of the POS terminal 2 generates the summed transaction information and the transaction information containing the recalculated tax exemption amount (Act S9).

The printing control section 2007 of the POS terminal 2 prints the summation receipt R2 (Act S10).

The printing control section 2007 of the POS terminal 2 determines whether or not the press on the summation origin receipt key 2083 is detected (Act S11). In a case in which the press on the summation origin receipt key 2083 is not detected (No in Act S11), the printing control section 2007 of the POS terminal 2 proceeds to the processing in Act S13.

On the other hand, in a case in which the press on the summation origin receipt key 2083 is detected (Yes in Act S11), the printing control section 2007 of the POS terminal 2 prints the summation origin receipt R3 (Act S12).

Next, the communication control section 2001 of the POS terminal 2 sends the generated transaction information to the store server 4 (Act S13). The store server 4 then enables the transaction information table T1 to store the transaction information.

According to the above, the POS terminal 2 terminates the transaction summing processing.

As stated above, according to the POS terminal 2 according to the present embodiment, the input control section 2002 reads the transaction codes printed on the summation object receipt R1. The transaction summing section 2004 sums the transactions corresponding to the transaction codes. Then, the transaction information generation section 2006 generates the transaction information relating to the summed transactions. The printing control section 2007 enables the summation receipt R2 relating to the summed transaction information and the summation origin receipt R3 in the form incapable of the summation relating to the transaction information summed by the transaction summing section 2004 to be printed. Thus, the nonresident can acquire not only the summation receipt R2 but also a receipt relating to the summation object to which a processing of preventing the unfair behavior is executed, and the unfair behavior of the double tax exemption can be prevented in the store.

While certain embodiments are described, these embodiments are presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Further, in the foregoing embodiment, the printing control section 2007 controls the printer 211 to print the summation object receipt R1, the summation receipt R2 and the summation origin receipt R3 on the paper such as a rolled paper. However, the present invention is not limited to this, the summation object receipt R1, the summation receipt R2 and the summation origin receipt R3 may be electronic receipts.

The programs executed by each device of the foregoing embodiment and modifications may be incorporated into a storage medium (ROM or storage section) of each device to be provided; however, the present invention is not limited to this. For example, the programs may be recorded in a computer-readable recording medium such as a CD-ROM, an FD (Flexible Disk), a CD-R, a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted through an LAN or an Internet.

Further, the programs executed by each device of the foregoing embodiment and the modifications is stored on a computer connected with a network such as an Internet and downloaded via the network to be supplied or may be supplied or distributed via the network such as the Internet.

What is claimed is:

1. A commodity sales data processing apparatus, comprising:
an input module configured to receive the input of identification information capable of identifying transaction information, stored in a storage section, which relates to one transaction in a commodity sales data processing;
an extraction module configured to extract the transaction information relating to the identification information received by the input module from the storage section;
a summing module configured to sum a plurality of the transaction information extracted by the extraction module; and
a print control module configured to print a summation receipt relating to the transaction information summed by the summing module and a summation origin receipt in the form incapable of the summation relating to the transaction information summed by the summing module.

2. The commodity sales data processing apparatus according to claim 1, wherein
the print control module does not print the identification information as the form incapable of the summation of the summation origin receipt.

3. The commodity sales data processing apparatus according to claim 1, wherein
the print control module prints information indicating summation completion on the summation origin receipt.

4. The commodity sales data processing apparatus according to claim 2, wherein
the print control module prints information indicating summation completion on the summation origin receipt.

5. The commodity sales data processing apparatus according to claim 1, wherein
the print control module prints the identification information as the form capable of the summation of the summation origin receipt.

6. The commodity sales data processing apparatus according to claim 1, wherein
the print control module prints the summation origin receipt in a case in which an operation of enabling the summation origin receipt to be printed is carried out.

7. A method for preventing unfair behavior by a commodity sales data processing apparatus, comprising:
receiving the input of identification information capable of identifying transaction information, stored in a storage section, which relates to one transaction in a commodity sales data processing;
extracting the transaction information relating to the received identification information from the storage section;
summing a plurality of the extracted transaction information; and
printing a summation receipt relating to the summed transaction information and a summation origin receipt in the form incapable of the summation relating to the summed transaction information.
